(19) United States
(12) Patent Application Publication
(10) Pub. No.: US 2016/0258466 A1
(43) Pub. Date: Sep. 8, 2016

(54) Method for Fastening Components

(71) Applicant: Bayerische Motoren Werke Aktiengesellschaft, Muenchen (DE)

(72) Inventor: Franz KORBER, Mallersdorf (DE)

(21) Appl. No.: 15/152,970

(22) Filed: May 12, 2016

Related U.S. Application Data
(63) Continuation of application No. PCT/EP2015/050586, filed on Jan. 14, 2015.

(30) Foreign Application Priority Data
Feb. 10, 2014 (DE) 10 2014 202 359.9

(51) Int. Cl. F16B 21/20; F16B 5/06

(52) U.S. Cl. CPC F16B 21/20; F16B 5/0642

(57) ABSTRACT

A method for fastening components, in particular sheet metal parts in vehicle body manufacturing, has the following steps: providing a first component having at least one receiving opening in a planar region of the first component, a plurality of clamping portions extending from the edge of the receiving opening in the direction of the center of the opening; providing a second component having at least one extension extending from a surface of the second component; and introducing the extension into the receiving opening, thereby bending the clamping portions.

### CROSS REFERENCE TO RELATED APPLICATIONS

This application is a continuation of PCT International Application No. PCT/EP2015/050586, filed Jan. 14, 2015, which claims priority under 35 U.S.C. §119 from German Patent Application No. 10 2014 202 359.9, filed Feb. 10, 2014, the entire disclosures of which are herein expressly incorporated by reference.

### BACKGROUND AND SUMMARY OF THE INVENTION

The invention relates to a method for fastening components, in particular sheet metal parts in vehicle body manufacturing.

In motor vehicle body manufacturing, sheet metal parts are positioned in relation to one another and fastened in the predetermined position before welding. This is effected, for example, with the aid of clamping frames, in which the sheet metal parts are held firmly by use of a complex receiving and clamping technique.

It is an object of the invention to simplify and reduce the cost of the fastening of components, while observing the high demands made on the accuracy of the positioning.

This and other objects are achieved by a method for fastening components, in particular sheet metal parts in vehicle body manufacturing. The method includes the following steps:

providing a first component having at least one receiving opening in a planar region of the first component, a plurality of clamping portions extending from the edge of the receiving opening in the direction of the center of the opening;

providing a second component having at least one extension extending from a surface of the second component: and

introducing the extension into the receiving opening, thereby bending the clamping portions.

The invention is based on the knowledge that, when fastening components, in particular sheet metal parts in vehicle body manufacturing, it is possible to dispense with complex clamping frames and the like if it is possible to achieve precise and stable positioning by effective clamping of the components. Precisely this is provided by the method according to the invention in that the extension of the second component is introduced into the receiving opening of the first component provided with the clamping portions.

The clamping portions extend originally in the direction of the center of the receiving opening (this not necessarily requiring the clamping portions to lie precisely in the same plane as that region of the component which surrounds the receiving opening). The clamping portions can simply be punched or cut out in another way together with the receiving opening. They replace the fastening elements which have been conventional to date, for instance coarse threaded bolts, projection nuts or the like, which have to be welded on in a complex working step.

Upon introduction, the clamping portions are bent by the extension. This bending of the clamping portions in the direction in which the extension is introduced is at least partially elastic. The clamping portions therefore exert a clamping force on the extension in the opposite direction, which has been found to be surprisingly large. The clamping force is adequate in any case to hold the second component with the extension in a defined and secure manner in the receiving opening, in particular if more than only one pair consisting of an extension and receiving opening is provided. In this case, the components to be joined can be held by gripping robots and can be moved in relation to one another in such a way that the extensions are introduced into the receiving openings.

A significant advantage of the invention is that the clamping portions automatically center the extension in the receiving opening given a suitable arrangement. Due to modern technology, the position, shape and dimensions of the receiving openings and extensions required for the invention can be manufactured in such a precise way that the high demands made on the fastening of components in vehicle body manufacturing are satisfied. The method according to the invention therefore makes it possible in a simple manner to build complex vehicle bodies without the receiving and clamping technique conventional to date.

It is ideally the case that the shape and the dimensions of the receiving opening (hole) are adapted precisely to the cross-sectional shape and dimensions of the extension. This gives rise to a defined positioning and fastening of the components without play.

It is preferable that the extension has a cylindrical portion, which is easy to produce. Accordingly, the receiving opening should have a diameter which is adapted to the diameter of the cylindrical portion. “Adapted” means that the diameter of the receiving opening is not smaller than, but at best slightly larger than, the diameter of the extension, it being necessary to take into consideration unavoidable tolerances and the bending radius of the clamping portions.

According to a preferred embodiment of the invention, the end face of the extension, which is remote from the surface of the second component, is closed. Such a design of the extension has the advantage that no open holes, which would otherwise have to be sealed off, are present after the components have been fastened. This is advantageous particularly for vehicle body manufacturing since the ingress of water is thereby largely prevented, and this is significant for corrosion protection. In addition, the closed extensions counteract undesirable sound propagation.

An extension which tapers toward the end thereof which is remote from the surface is advantageous with respect to assembly. This design supports the introduction of the extension into the associated receiving opening, since a conically shaped end facilitates the bending of the clamping portions.

For a uniform distribution of force over the extension, the clamping portions should be distributed uniformly over the circumference of the receiving opening. As a result, the extension is not pressed unnecessarily to one side. A uniform distribution of the clamping portions also ensures optimum centering of the extension in the receiving opening.

When designing the clamping portions, it should be ensured that the distances between the clamping portions in the circumferential direction of the receiving opening are such that the clamping portions do not make mutual contact upon bending. The consequence would otherwise be a suboptimal clamping action.

One measure for increasing the bending resistance of the clamping portions is the provision of shaped stamped portions in the bending region. By way of example, beads extending transversely over the bending axis make it possible to produce additional moments of resistance in order to increase the effort required for bending the clamping portions. As a result, the clamping force on the extension conversely is increased.

According to one development of the invention, three or more components can be fastened in relation to one another by initially arranging at least two components having substantially congruent receiving opening one above another in such a way that the central axes of the receiving openings coincide and the clamping portions of the components arranged one above another do not overlap. Then, a further component having an extension is introduced into the receiving openings so as to bend the clamping portions of the components arranged one above another.

As already mentioned, the receiving opening(s) (hole(s)) and the clamping portions can advantageously be produced in only one punching step. Reworking is generally not required. This means that the component having the receiving opening(s) and the clamping portions can be manufactured in an off-tool manner in a pressing plant.

An extension according to the invention is formed in the simplest manner by deep-drawing the second component. This technique has been successful for a long time and allows for a precise design of the extension.

After the (preliminary) positioning and fastening of the components by way of the extensions and receiving opening, the components can be joined to one another without further positioning aids, in particular by welding, either in order “to freeze” the fastening before further machining or mounting or in order to ultimately connect the components to one another.

Other objects, advantages and novel features of the present invention will become apparent from the following detailed description of one or more preferred embodiments when considered in conjunction with the accompanying drawings.

### BRIEF DESCRIPTION OF THE DRAWINGS

FIGS. 1a to 1d show plan views onto components having receiving openings and clamping portions in various embodiment variants;

FIG. 2 shows a plan view onto a receiving opening and a lateral sectional view of an extension;

FIGS. 3a and 3b show two lateral sectional views of a receiving opening and of an extension in two successive steps of the method according to the invention;

FIG. 4 shows a plan view onto two components which are lying one on top of the other and have receiving openings and clamping portions;

FIG. 5 shows a lateral sectional view of an extension fastened in the receiving openings of the components shown in FIG. 4: and

FIGS. 6a and 6b show lateral sectional views of a pressing plant in two successive steps during the production of an extension.

### DETAILED DESCRIPTION OF THE DRAWINGS

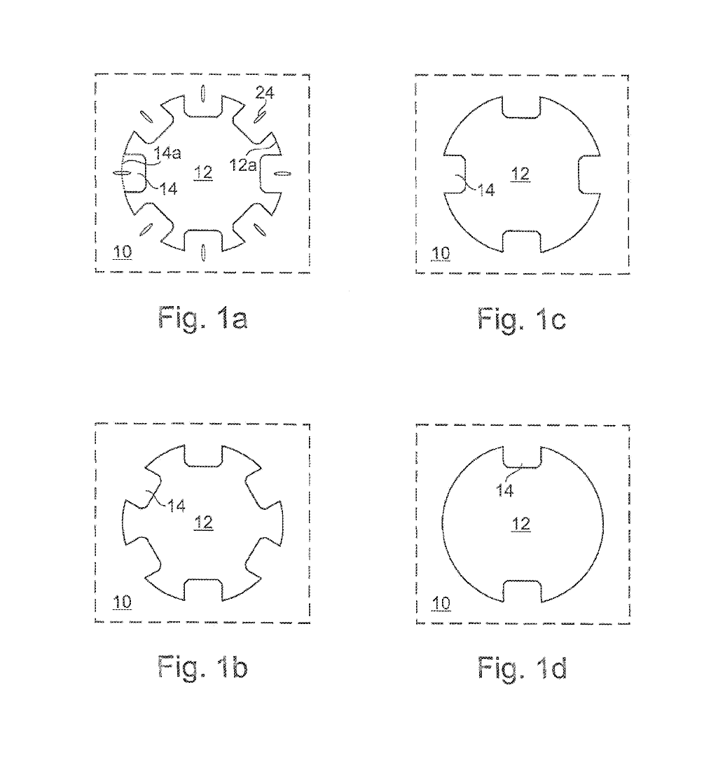

FIGS. 1a to 1d each show a planar or plate-like (i.e. flat) region of a first component 10 having a receiving opening (hole) 12 and a plurality of clamping portions 14. The clamping portions 14 extend from the edge 12a of the receiving opening 12 in the direction of the center of the opening. In the embodiment variants shown, the clamping portions 14 are distributed uniformly over the edge 12a of the receiving opening 12, i.e. the distances between adjacent clamping portions 14 are always the same in the circumferential direction. Although the uniform distribution of the clamping portions 14 is advantageous for the operation thereof, which will be explained hereinbelow, it is not absolutely necessary, particularly given a small number of clamping portions 14. Eight clamping portions 14 are provided in FIG. 1a, six clamping portions 14 are provided in FIG. 1b, four clamping portions 14 are provided in FIG. 1c, and two clamping portions 14 are provided in FIG. 1d. It goes without saying that an odd number of clamping portions 14 is also possible. The minimum number is two, however.

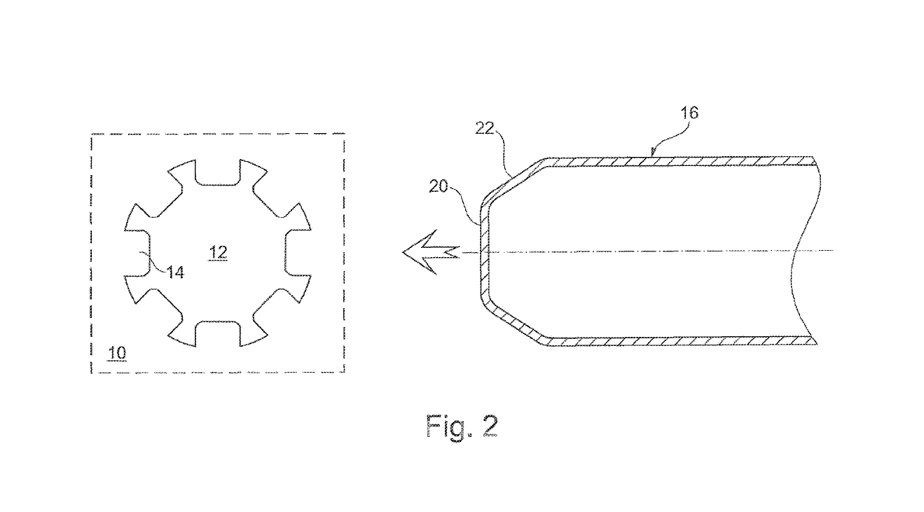

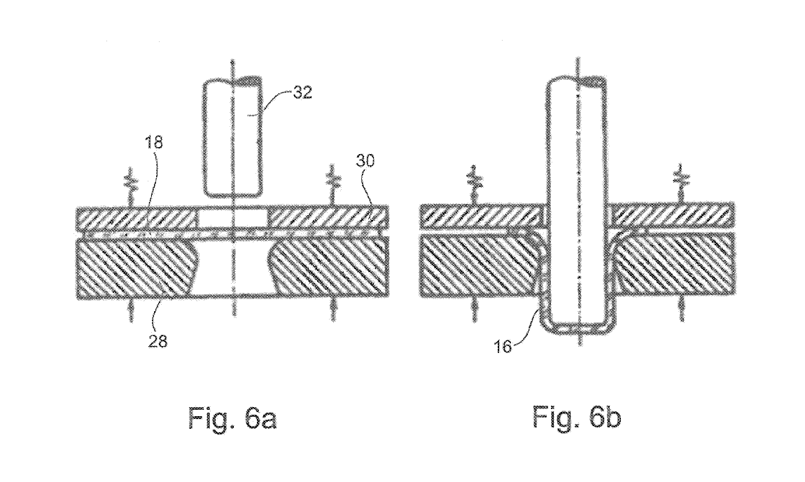

FIG. 2 shows an extension 16 extending from a surface of a second component 18 (not visible in FIG. 2, see FIG. 6a for example). The extension 16 in this case is tubular, the end face 20 which is remote from the component surface being closed. According to the exemplary embodiment shown, the extension 16 is rotationally symmetrical, more precisely cylindrical. Only that end portion 22 of the extension 16 which is remote from the component surface tapers conically. The diameter of the cylindrical portion of the extension is matched to the diameter of the receiving opening 12, i.e. it is slightly smaller.

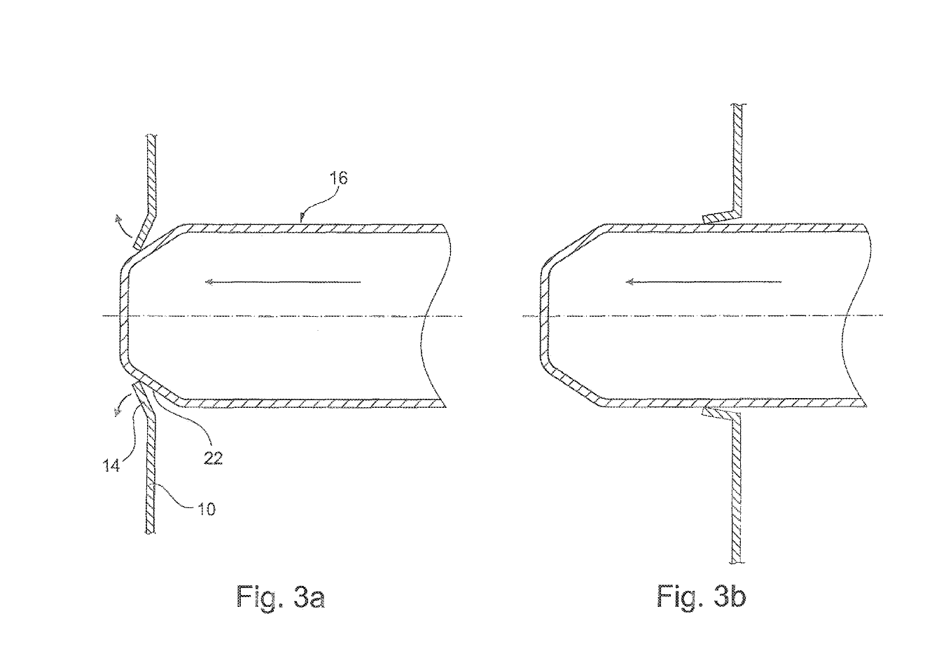

FIGS. 3a and 3b show how the two components 10, 18 are fastened. The second component 18 is moved toward the first component 10 in such a way that the extension 16 is introduced into the associated receiving opening 12, this being facilitated by the conically shaped end portion 22. As the extension 16 is being introduced, it comes into contact with the clamping portions 14, and bends the latter around the edge 12a (which is virtual at this point) of the receiving opening 12. The clamping portions 14 thus counter the introduction of the extension 16 with a resistance. This resistance is utilized in turn for fastening the extension 16 in the receiving opening 12. Since the deformation of the clamping portions 14 is at least partially elastic, the clamping portions 14 exert a relatively large clamping force on the extension 16. As a result, the second component 18 is held securely on the first component.

The clamping portions 14 arranged all around moreover ensure that the extension 16 is automatically centered, this being possible with a very small tolerance. The centering is promoted by a large number of clamping portions 14, which all have the same shape and are distributed uniformly over the circumference of the receiving opening 12.

To determine the axial position of the second component 18 in relation to the first component 10, a stop or comparable aid which delimits the depth of introduction can be provided.

Although the clamping force exerted on the extension 16 is already very large, additional measures for “freezing” the fastening can nevertheless be provided. Thus, the clamping portions 14 can be welded to the extension, for example by fillet welding at the free supporting edge of the clamping portions or by build-up welding, in order to connect a supporting surface of the clamping portions 14 to the extension 16.

The number of clamping portions 14 at a receiving opening 12 typically depends on the thickness of the component region in which the receiving opening 12 is located. The following applies in principle: the thinner the material, the greater the number of clamping portions 14. Therefore, the force required to bend eight clamping portions 14 having a thickness of 0.8 mm is approximately comparable to the force required to bend four clamping portions 14 having a thickness of 1.3 mm.

A further possibility for adapting or finely adjusting the effort required for introducing an extension 16 into an associated receiving opening 12, and therefore the clamping force, is to vary the width of the webs 14a of the clamping portions 14 (see FIG. 1a). A clamping portion 14 having a relatively short web width can be bent more readily than a clamping portion 14 having a relatively large web width.

If the clamping force is to be increased (still further), shaped stamped portions 24, in particular in the form of beads, can be provided at some or all of the clamping portions 14. In the case of the exemplary embodiment shown in FIG. 1a, the shaped stamped portions 24 extend in the center of the clamping portions 14 transversely over the webs 14a, the longitudinal axis of the shaped stamped portions 24 in each case being oriented substantially perpendicularly to the web width 14a During the introduction of the extension 16 into the receiving opening 12, the shaped stamped portions 24 provide additional moments of resistance, and these make it harder for the clamping portions 14 to be bent.

Depending on the requirements and manufacturing conditions, the size of an extension 16 can range from having diameters and lengths in the millimeter range up to the centimeter or even meter range, if for example large steel components are to be fastened. The diameter of each receiving opening 12 is adapted to the diameter of the respectively associated extension 16.

The extensions 16 do not necessarily have to have a circular cross section, but instead can also be elliptical or angular, it being necessary for the shape of the associated receiving openings 12 to be adapted accordingly. Particularly in the case of an angular design, this can predefine a specific orientation of the two components 10, 18 to be fastened.

In the case of relatively large components, a multiplicity of pairs consisting of an extension and a receiving opening are generally provided. In this case, a component can have both receiving openings 12 and extensions 16 assigned in each case to corresponding extensions 16 and receiving openings 12 of the other component.

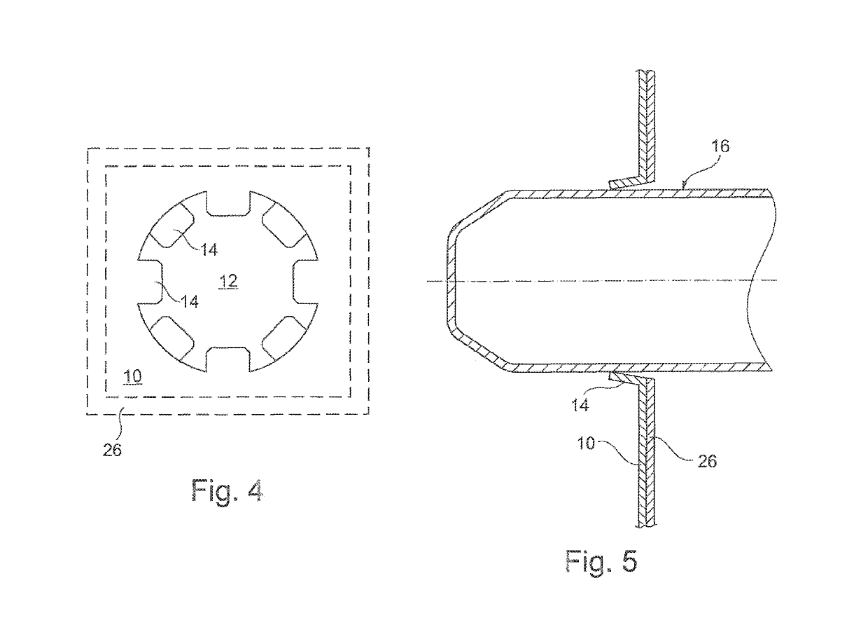

FIGS. 4 and 5 show how the two components 10, 18 and a third component 26 can be fastened in relation to one another. The two components 10 and 26 each have a receiving opening 12 with the same diameter. As can be seen in FIG. 4, the two components 10, 26 are arranged one above the other in such a way that the central axes of the receiving openings 12 coincide. The number of clamping portions 14 projecting into the receiving openings 12 and the (rotational) arrangement of the two components 10, 26 in relation to the central axes of the receiving openings 12 are chosen in such a way that the clamping portions 14 of the two components 10, 26 do not mutually overlap. This means that the clamping portions 14 of the component 10 are located in the gaps between the clamping portions 14 of the component 26, and vice versa.

If, as shown in FIG. 5, the extension 16 of the second component 18 is then introduced into the receiving openings 12, the extension 16 bends both the clamping portions 14 of the first component 10 and also the clamping portions 14 of the third component 26. As a result, both the first and the third component 10, 26 are held on the extension 16 of the second component 18. The number and the arrangement of the clamping portions 14 of the two components 10, 26 are chosen in such a way that they do not make mutual contact during bending.

An even greater number of components stacked one on top of another can be fastened in the same way. The length of the extension(s) 16 is then to be chosen to be adequately large.

Particularly in the case of sheet metal parts, the receiving openings 12 and the clamping portions 14 can be produced in a simple manner by punching, with only a single punching step being required.

The extensions 16 can be produced by deep-drawing, as shown by way of example in FIGS. 6a and 6b. The component 18 is inserted between a drawing ring 28 and a resilient holding-down device 30 (FIG. 6a), before a punch 32 is pressed down in order to shape the extension 16 (FIG. 6b). The shape of the punch 32 essentially determines the shape of the extension 16.

### LIST OF REFERENCE SIGNS

10 first component
12 receiving opening (hole)
12a edge
14 clamping portions
14a web
16 extension
18 second component
20 end face
22 end portion
24 shaped stamped portion
26 third component
28 drawing ring
30 holding-down device
32 punch

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A method for fastening components, the method comprising the acts of:
providing a first component having at least one receiving opening in a planar region of the first component, wherein a plurality of clamping portions extend from an edge of the receiving opening in a direction of a center of the opening;
providing a second component having at least one extension extending from a surface of the second component; and
introducing the extension into the receiving opening, thereby bending the clamping portions.

2. The method according to claim 1, wherein a shape and dimensions of the receiving opening are adapted to a cross-sectional shape and dimensions of the extension.

3. The method according to claim 1, wherein the extension has a cylindrical portion, and the receiving opening has a diameter which is adapted to a diameter of the cylindrical portion.

4. The method according to claim 1, wherein an end face of the extension, which is remote from a surface of the second component, is closed.

5. The method according to claim 1, wherein the extension tapers toward an end thereof which is remote from a surface of the second component.

6. The method according to claim 1, wherein the clamping portions are distributed uniformly over a circumference of the receiving opening.

7. The method according to claim 1, wherein distances between the clamping portions in a circumferential direction of the receiving opening are such that the clamping portions do not make mutual contact upon bending.

8. The method according to claim 1, wherein shaped stamped portions, which extend transversely over bending axes of the clamping portions, are provided to increase bending resistance of the clamping portions in a bending region.

9. The method according to claim 8, wherein the shaped stamped portions are beads.

10. The method according to claim 1, further comprising the act of:
providing a third component so that at least three components are fastened in relation to one another by initially arranging at least two of the components having substantially congruent receiving openings one above another such that the central axes of the receiving openings coincide and the clamping portions of the two components arranged one above another do not overlap, and then introducing a further of the three components having an extension into the receiving openings so as to bend the clamping portions of the components arranged one above another.

11. The method according to claim 2, wherein the receiving opening and the clamping portions are produced in only one punching step.

12. The method according to claim 1, wherein the extension is formed by deep-drawing the second component.

13. The method according to claim 1, wherein the first and second components are joined to one another without further positioning aids.

14. The method according to claim 1, wherein the first and second components are sheet metal vehicle body parts.

15. The method according to claim 10, wherein the at least three components are sheet metal vehicle body parts.
